(19) United States
(12) Patent Application Publication
(10) Pub. No.: US 2024/0411351 A1
(43) Pub. Date: Dec. 12, 2024

(54) A COMPUTERIZED CHARGING/INTERFACE DEVICE WITH APPLICATION MARKETPLACE AND ECOSYSTEM CAPABILITIES

(71) Applicant: B.G. NEGEV TECHNOLOGIES AND APPLICATIONS LTD., AT BEN-GURION UNIVERSITY, BEER-SHEVA (IL)

(72) Inventor: Mordechai GURI, NOF AYALON (IL)

(21) Appl. No.: 18/699,780

(22) PCT Filed: Oct. 6, 2022
(86) PCT No.: PCT/IL2022/051066

§ 371 Date: Apr. 9, 2024

Related U.S. Application Data
(60) Provisional application No. 63/254,122, filed on Oct. 10, 2021.

(51) Int. Cl. G06F 1/26; G06F 8/656; G06F 21/56

(52) U.S. Cl. CPC G06F 1/266; G06F 8/656; G06F 21/56; G06F 2221/033

(57) ABSTRACT

A computerized charger for a mobile device, comprising a charging unit having an AC cord for charging the battery of the mobile device; a communication and power supply cable connected to a charging interface of the mobile device; at least one processor and associated memory, for implementing a computation device, being capable of performing backup and malware detection operations; a communication port, connected to a communication channel to at least one remote computer/server having an operating software coupled to an API; one or more software modules or applications, stored in the memory and run by the processor, the operating software and the one or more software modules or applications being adapted to during charging periods of the mobile device, provide via the API, secured access by application developers to predetermined files in the mobile device, for allowing the application developers to create and store, dedicated applications; download via the communication port, one or more of the dedicated applications into the associated memory or into the mobile device, to be run by the OS of the mobile device alone, or in conjunction with the processor and the one or more software modules or applications.

### FIELD OF THE INVENTION

The present invention relates to the field of smart chargers. More particularly, the invention relates to a computerized interface device such as a charger, for mobile devices, with application marketplace and ecosystem capabilities.

### BACKGROUND OF THE INVENTION

Nowadays, there are different kinds of conventional antivirus applications for mobile devices. The operating system of mobile devices, such as smartphones, is manufactured by a manufacturer who gives limited access to files in the mobile files, since the operating system does not give full access to all the files, but only to a part of them.

This limited access is determined due to security reasons. If the antivirus application will get full access to all mobile device files, viruses and malware will also have access to these files. In this case, viruses will be able to penetrate the mobile device's files and cause heavy damage, which can even disable the entire device. The limited access to the files of the mobile device made these conventional antivirus applications limited. Therefore, they are not sufficiently efficient.

The way to access all the files on the mobile device is only through a physical connection by a suitable cable and interface (a USB connection, for example).

Smartphones, tablets and other mobile devices are being charged on a regular basis. The charging is performed via a conventional connecting interface (e.g., a USB connection or via an inductive charging interface). However, these interfaces are able to connect the device to other functionalities, such as a file system, and internal storage. These interfaces are also able to use the device functionalities while charging the device.

Mobile devices are also used as a payment device for conducting online transactions. However, the security keys for these transactions are normally stored in the device and therefore, are vulnerable to cyber-attacks or can be stolen in case when the mobile device is stolen or lost.

It is therefore an object of the present invention to provide a computerized charging device that has full access to all mobile device files and efficient malware detection capability.

It is another object of the present invention to provide a computerized charging device with malware detection and prevention capability with a deep scan for viruses, attackers, spyware, and ransomware.

It is a further object of the present invention to provide a computerized charging device with malware detection capability, which provides secure access to an application marketplace.

It is still another object of the present invention to provide a computerized charging device with remote maintenance and repair capabilities.

It is yet another object of the present invention to provide a computerized charging device with security key applications, for performing secure payments and saving sensitive information.

Other objects and advantages of the invention will become apparent as the description proceeds.

### SUMMARY OF THE INVENTION

A computerized charger for a mobile device, comprising:
a) a charging unit having an AC cord for charging the battery of the mobile device;
b) a communication and power supply cable connected to a charging interface of the mobile device;
c) at least one processor and associated memory, for implementing a computation device, being capable of performing backup and malware detection operations;
d) a communication port, connected to a communication channel to at least one remote computer/server having an operating software coupled to an API; and
e) one or more software modules or applications, stored in the memory and run by the processor, the operating software and the one or more software modules or applications being adapted to:
   e.1) during charging periods of the mobile device, provide via the API, secured access by application developers to predetermined files in the mobile device, for allowing the application developers to create and store, dedicated applications;
   e.2) download via the communication port, one or more of the dedicated applications into the associated memory or into the mobile device, to be run by the OS of the mobile device alone, or in conjunction with the processor and the one or more software modules or applications.

The predetermined files in the mobile device may be selected from the group of:
OS files;
communication protocols;
data files;
The communication and power supply cable may be a USB or micro-USB cable.

The services provided to the mobile device during charging, may be one or more of the following:
offline and online backup of files and applications;
deep malware scanning for new viruses, the presence of attackers, spyware and ransomware;
data encryption;
data comparison;
data restoration;
connection to an application marketplace containing dedicated applications developed for the mobile device by third-party developers;
remote maintenance and repair applications using the physical connection between the smart charger and the mobile device.

The communication channel may be a wireless channel.

The computerized charger may be adapted to delete or quarantine suspicious detected files.

The computerized charger may also be adapted to:
issue warnings and indications to the user regarding malicious files;
delete suspected files;
block the operation of suspected files;
clean malicious applications;
perform software updates.

The mobile device may be one of the following:
a smartphone;
a wearable smartwatch;
smart glasses.

The dedicated applications may include one or more of the following:
key applications stored on the smart-charger to authenticate e-wallet transactions and secure payments;
saving personal or sensitive information external to the mobile device;
key storage applications for implementing secure electronic wallets, Non-Fungible Tokens (NFTs);
authentication and identification applications;
biometric applications, based on data received from biometric sensors that reside on the smart charger;
an application ecosystem for synchronization between different mobile devices being connected to the smart charger, according to the user's profile and other predefined parameters.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 shows a block diagram of the smart-charger of the present invention, and the connectivity of the smart charger to other systems.

### DETAILED DESCRIPTION OF THE INVENTION

The present invention provides a computerized charging device (“a smart charger”) that has full access to all mobile device files and efficient malware detection capability that does not entail large battery (energy) consumption. The computerized charging device is also adapted to provide backup and a high level of security and other functionalities regarding the maintenance, backup and security of the device. The computerized charging device is also adapted to provide other capabilities, such as access to an application marketplace that includes dedicated applications that will be developed for the computerized charging device and the charged mobile device. These dedicated applications can be developed by third parties which will have access to dedicated libraries and files via an Application Programming Interface (API). Such dedicated applications may be related to cyber security, secure payment and remote maintenance, as will be described later on.

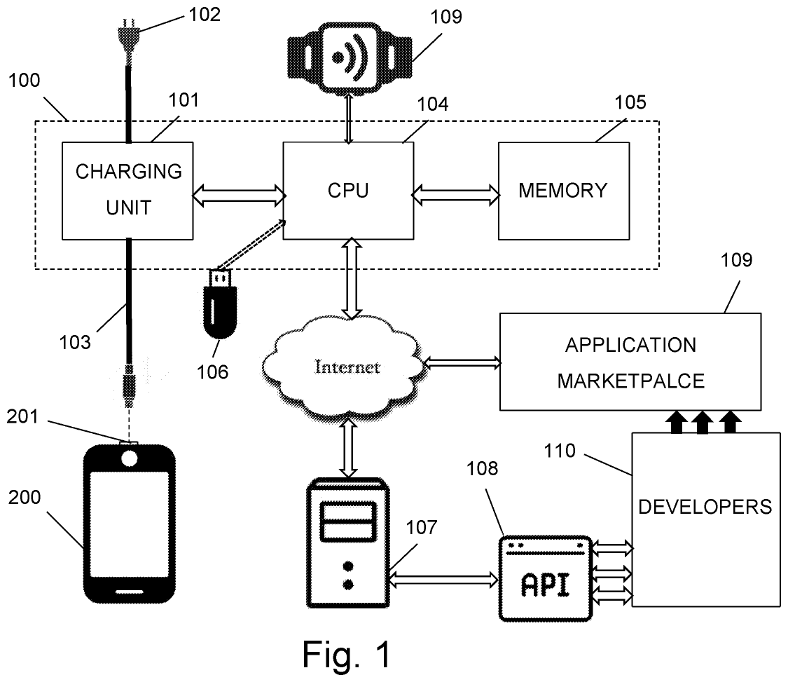

FIG. 1 is a block diagram of the smart charger provided by the present invention. The smart charger 100 comprises a standard charging unit which is connected by an AC cord to the AC power line and converts the AC power to charging DC power that is fed via a communication and power supply cable 103 (such as USB) into the charging socket 201 of a mobile device 200 (which can be, for example, a smartphone, a wearable smartwatch or smart glasses).

The smart charger 100 also comprises a processor 104 and associated memory 105 which implement a computation device (a kind of portable computer) that is capable of performing backup and malware detection operations. The CPU 104 is coupled to the communication and power supply cable 103 (e.g., a USB or micro-USB cable) and therefore, has direct and full access to all files in the mobile device 200. The smart charger 100 also comprises a communication port, connected through a communication channel to at least one remote computer/server with an operating software that is coupled to an API.

CPU 104 runs several software modules or applications, which are stored in the memory 105 and are adapted to provide a variety of services, as will be described later on. During charging periods of said mobile device, these software modules or applications provide via the API 108, secured access by application developers to predetermined files in the mobile device, for allowing the application developers to create and store dedicated applications. The software modules or applications are also adapted to download (via the communication) port, one or more of the dedicated applications into the associated memory or into the mobile device, to be run by the OS of the mobile device alone, or in conjunction with the processor and the software modules or applications. The services provided to the mobile device during charging, may include offline and online backup of files and applications, deep malware scanning for new viruses, the presence of attackers, spyware and ransomware, scanning and analysis of files and logs, for the detection of attacks or malware, data encryption, data comparison, data restoration, connection to an application marketplace containing dedicated applications developed for the mobile device by third-party developers, remote maintenance and repair applications using the physical connection between the smart charger and the mobile device.

### Offline and Online Backup

When the smart-charger 100 is connected to the mobile device 200, it starts charging its battery. During charging, the CPU 104 performs a backup of the file system of the mobile device to an offline storage device, such as a Disk-On-Key (or a USB flash drive-a data storage device that includes flash memory with an integrated USB interface) or a memory stick (a proprietary removable flash memory card format created by Sony Corporation). The backup operation may be full (i.e., storing all files) or incremental (i.e., storing only new files). The storage device may be integrated into the charger 100 or may be inserted as an external storage device 106 into a mating socket (such as a USB).

During charging of the mobile device 200 by the smart-charger 100 the CPU 104 performs an online backup of the file system of the mobile device to an online storage medium. Data to be stored may be uploaded online, to a computational cloud (not shown). The communication channel for data transfer (storage and retrieval) between the smart-charger 100 and the online storage medium may be, for example, a wireless channel, such as a WiFi connection (using a dedicated WiFi chip).

According to another embodiment, the API may be used to develop backup applications. By using the smart charger 100 with such a backup application, it will be possible to perform a deep backup of part or all of the device periodically to the cloud or locally to the component, and perform various operations on the data, such as encryption, comparison, restoration, etc.

The computerized charger is also adapted to delete or quarantine suspicious detected files in the mobile device, issue warnings and indications to the user regarding malicious files in the mobile device, delete suspected files in the mobile device, block the operation of suspected files in the mobile device, clean malicious applications in the mobile device and perform software updates in the mobile device.

The smart charger 100 may include dedicated software applications that will be installed and run, using its computational resources. For example, a dedicated software application may be a token for authenticating transactions made by the mobile device.

### Connection to an Application Marketplace

An application marketplace is an online store where customers can go to find and purchase applications and download them onto their computers, phones, or other devices, or use the store as a central location to use and manage cloud-based products and services. According to another embodiment, the application marketplace 109 will include dedicated applications that will be developed by developers 110 for the computerized charging device and the charged mobile device. These dedicated applications can be developed by third parties which will have access to dedicated libraries and files via an API 108. For example, developers of antivirus companies will be able to access, via a dedicated API 108 that resides on a remote server 107, predetermined files (such as low-level files in the operating system of the mobile device, OS files, communication protocols and data files), communication protocols and libraries that support a plurality of mobile devices. The ability to read deep information from the device through the connection to the smart charger allows the developing of applications that will enable a deep scan for new viruses, the presence of attackers, spyware (a type of malicious software or malware that is installed on a computing device without the end user's knowledge), and ransomware (malware in which the data on a victim's computer is locked by encryption and payment is demanded before the ransomed data is decrypted and access is returned to the victim). The dedicated applications may include key applications stored on the smart-charger to authenticate e-wallet transactions and secure payments, saving personal or sensitive information external to the mobile device, key storage applications for implementing secure electronic wallets, Non-Fungible Tokens (NFTs), authentication and identification applications, biometric applications, based on data received from biometric sensors that reside on the smart charger, an application ecosystem for synchronization between different mobile devices being connected to the smart charger, according to the user's profile and other predefined parameters.

Also, a dedicated application may be adapted to perform scanning and analysis of files and logs, for the detection of attacks or malware. For example, anti-virus companies can develop applications that scan and test various applications and components in the operating system of the mobile device. This way, the developers 110 will be able to create updated antivirus applications that are suitable for each charged mobile device. The developed applications may be downloaded by the smart-charger 100 via a WiFi connection and installed into the mobile device during charging.

### Remote Maintenance and Repair Applications

In another embodiment, a third party can use the provided API 108 to develop applications for the purpose of maintaining and repairing damaged software and update the mobile device remotely, during normal operation. Also, if the mobile device malfunctions or does not boot, maintenance and repair can be done using the physical connection between the smart charger and the mobile device.

In another embodiment, by using developed key applications, the keys used to authenticate e-wallet transactions will be stored on the smart-charger 100 (rather than on the mobile device) and therefore, will be more protected, in a case when the mobile device will be lost or stolen.

According to another embodiment, the API 108 may be used to develop key applications for performing secure payments and saving personal or sensitive information. Due to the operation of the external smart charger outside the mobile device, it is possible to develop key storage applications for implementing secure electronic wallets, as well as Non-Fungible Tokens (NFTs—an NFT is a record on a blockchain which is associated with a particular digital or physical asset. The ownership of an NFT is recorded in the blockchain, and can be transferred by the owner, thereby allowing NFTs to be traded. NFTs can be created by anybody, and require few or no coding skills to create. NFTs typically contain references to digital files such as photos, videos, and audio. Because NFTs are uniquely identifiable assets, they differ from cryptocurrencies, which are fungible), while reaching a high level of encryption. This way, attackers on the mobile device will not be able to cause damage to the mobile device or the applications installed on it.

According to another embodiment, the API 108 may be used to develop authentication and identification applications. In this embodiment, the mobile device can be authenticated against the smart charger, to verify the user's identity. In this case, only a physical connection with the smart charger will allow the opening and operating of the mobile device.

According to another embodiment, the API 108 may be used to develop biometric applications, based on data (such as fingerprints or audio data) received from biometric sensors that reside on the smart charger 100. These biometric sensors are protected from malware, since they do not reside on the mobile device 200.

According to another embodiment, the API 108 may be used to develop an application_ecosystem (the term ecosystem refers to the connections between applications and to modern business operations supported by a series of related, complimentary applications), used for synchronization between different mobile devices. The related applications can synchronize between several devices (different phones, watches, etc.) that are connected to the smart charger, according to the user's profile and other predefined parameters.

As various embodiments and examples have been described and illustrated, it should be understood that variations will be apparent to one skilled in the art without departing from the principles herein. Accordingly, the invention is not to be limited to the specific embodiments described and illustrated in the drawings.

1. A computerized charger for a mobile device, comprising:
a) a charging unit having an AC cord for charging the battery of said mobile device;
b) a communication and power supply cable connected to a charging interface of said mobile device;
c) at least one processor and associated memory, for implementing a computation device, being capable of performing backup and malware detection operations;
d) a communication port, connected, via a communication channel, to at least one remote computer/server having an operating software coupled to an API; and
e) one or more software modules or applications, stored in said memory and run by said at least one processor, said operating software and said one or more software modules or applications being adapted to:
e1) during charging periods of said mobile device, provide via said API, secured access, by application developers, to predetermined files in said mobile device, for allowing said application developers to create and store dedicated applications;
e2) download via said communication port, one or more of said dedicated applications into said associated memory or into said mobile device, to be run by the Operating System (OS) of said mobile device, alone, or in conjunction with said at least one processor and said one or more software modules or applications.

2. The computerized charger according to claim 1, wherein the predetermined files in said mobile device are selected from the group of:
OS files;
communication protocols; and
data files.

3. The computerized charger according to claim 1, wherein the communication and power supply cable is a USB or micro-USB cable.

4. The computerized charger according to claim 1, wherein the services provided to the mobile device during charging, are one or more of the following:
offline and online backup of files and applications;
deep malware scanning for new viruses, the presence of attackers, spyware and ransomware;
scanning and analysis of files and logs, for the detection of attacks or malware;
data encryption;
data comparison;
data restoration;
connection to an application marketplace containing dedicated applications, developed for the mobile device by third-party developers; and
remote maintenance and repair applications using the physical connection between the smart charger and the mobile device.

5. The computerized charger according to claim 1, wherein the communication channel is a wireless communication channel.

6. The computerized charger according to claim 1, being adapted to delete or quarantine suspicious detected files.

7. The computerized charger according to claim 1, being adapted to:
issue warnings and indications to the user regarding malicious files;
delete suspected files;
block the operation of suspected files;
clean malicious applications;
perform software updates.

8. The computerized charger according to claim 1, wherein the mobile device is one of the following:
a smartphone;
a wearable smartwatch;
smart glasses.

9. The computerized charger according to claim 1, wherein the dedicated applications include one or more of the following:
key applications stored on the smart-charger to authenticate e-wallet transactions and secure payments;
saving capability of personal or sensitive information external to the mobile device;
key storage applications for implementing secure electronic wallets, Non-Fungible Tokens (NFTs);
authentication and identification applications; and
biometric applications, based on data received from biometric sensors that reside on the smart charger;
an application ecosystem for synchronization between different mobile devices being connected to the smart charger, according to the user's profile and other predefined parameters.
